(19) United States
(12) Patent Application Publication
(10) Pub. No.: US 2013/0166954 A1
(43) Pub. Date: Jun. 27, 2013

(54) TEST APPARATUS FOR TESTING SIGNAL TRANSMISSION OF MOTHERBOARD

(71) Applicant: LI XU, Shenzhen City (CN)

(72) Inventor: LI XU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/568,041

(22) Filed: Aug. 6, 2012

(30) Foreign Application Priority Data
Dec. 24, 2011 (CN) 201110438415.3

(51) Int. Cl. G06F 11/273

(52) U.S. Cl. 714/27; 714/E11.171

(57) ABSTRACT

A test apparatus for testing peripheral component interconnect express (PCIe) signals transmission of a motherboard includes a printed circuit board including an edge connector, a number of first switches having a same number with the type of the PCIe signals to be test, an encoder, and a microprocessor. The first switches are used to select a type selection signal. The encoder converts signals outputted from the first switches to binary data. The microprocessor outputs clock signals to a PCIe controller according to the binary data to make the PCIe controller transmit the PCIe signal to the PCIe slot.

### BACKGROUND

1. Technical Field

The present disclosure relates to a test apparatus for testing peripheral component interconnect express (PCIe) signal transmission of a motherboard.

2. Description of Related Art

PCIe 3.0 bus can transmit many types of signals. According to characteristics of the PCIe 3.0, when a central processing unit (CPU) receives a control signal that lasts one millisecond, a motherboard will output a next type of PCIe 3.0 signal. As a result, to test the motherboard, operators need to control the CPU to output the control signal using a switch. Such a test method is at risk or even prone to human error.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present embodiments. Moreover, in the drawings, like reference numerals designate corresponding parts throughout the several views.

FIGS. 1 and 2 are circuit diagrams of an exemplary embodiment of a test apparatus.

FIG. 3 is a plan view of a first side of the test apparatus of FIG. 1.

FIG. 4 is a plan view of a second side of the test apparatus of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

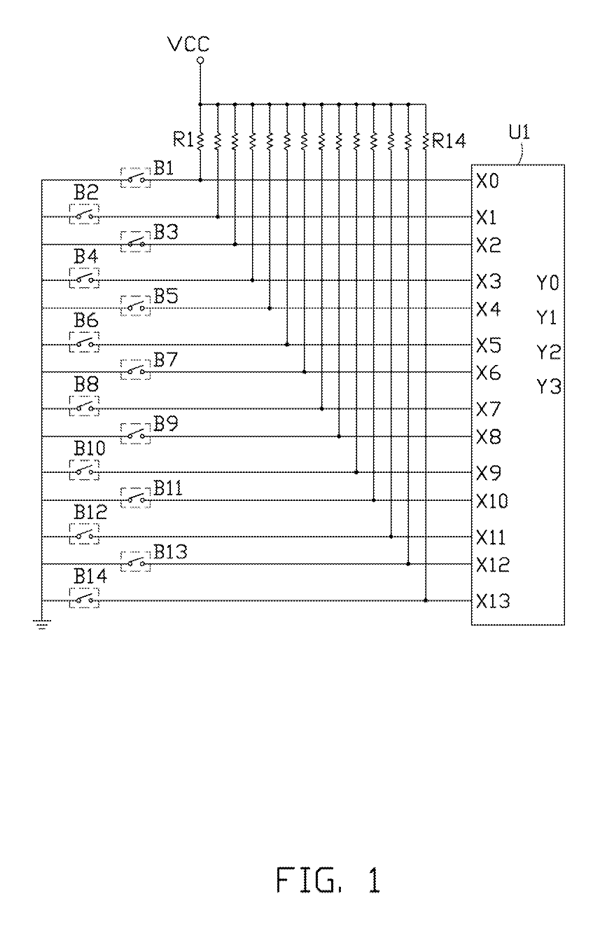

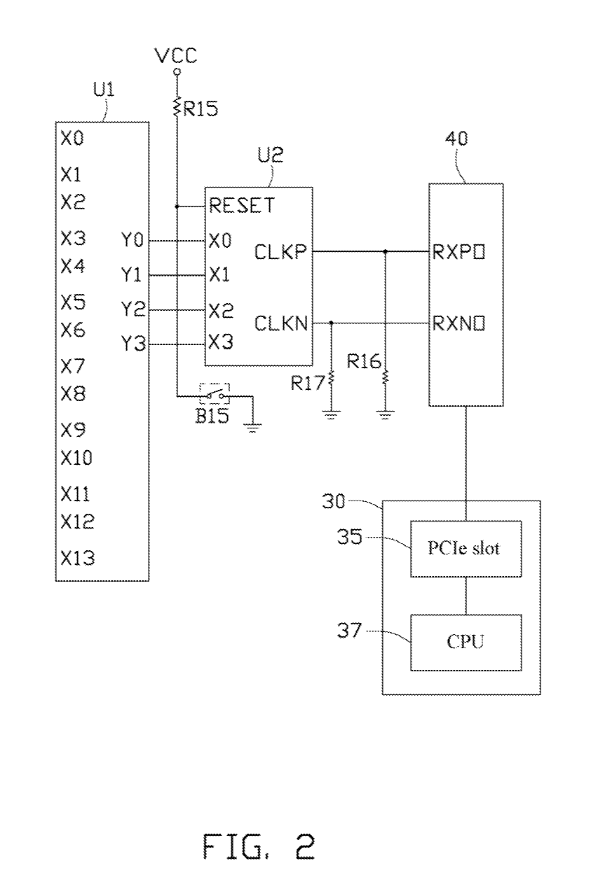

Referring to FIGS. 1-4, a test apparatus is used to test peripheral component interconnect express (PCIe) signal transmission by a motherboard 30. An exemplary embodiment of the test apparatus includes a printed circuit board 50, switches B1-B14, an encoder U1, a microprocessor U2, and connection terminals J1-J16.

First ends of switches B1-B14 are grounded. A second end of the switch Bx is connected to a DC power VCC through a resistor Rx (FIG. 1 just showing R1 and R14 labeled), where x is a natural number less than 15. For example, a second end of the switch B1 is connected to the DC power VCC through a resistor R1, and a second end of the switch B14 is connected to the DC power VCC through a resistor R14. In other embodiments, the test apparatus may include more or less than fourteen switches according to the number of the types of PCIe signals.

The encoder U1 includes inputs X0-X13 and outputs Y0-Y3. The inputs X0-X13 are respectively connected to the second ends of the switches B1-B14. The encoder U1 converts signals received by the inputs X0-X13 to binary data and outputs the binary data through the outputs Y0-Y3 to the microprocessor U2.

The microprocessor U2 includes inputs X0-X3, a reset pin RESET, and two clock pins CLKP and CLKN. The inputs X0-X3 are respectively connected to the outputs Y0-Y3 of the encoder U1. The reset pin RESET is grounded through a switch B15. The reset pin RESET is further connected to the DC power VCC through a resistor R15. The clock pin CLKP is grounded through a resistor R16. The clock pin CLKN is grounded through a resistor R17. The microprocessor U2 outputs a type selection signal according to the binary data received by the inputs X0-X3. In the embodiment, each type selection signal is a clock signal which lasts one millisecond. An interval between every two successive type selection signals is ten milliseconds. The switch B15 is used to reset the microprocessor U2.

The printed circuit board 50 includes an edge connector 40. When the edge connector 40 is plugged into a PCIe slot 35 on the motherboard 30, the edge connector 40 is connected to terminals of the PCIe slot 35. A pin RXP0 of the edge connector 40 is connected to the clock pin CLKP of the microprocessor U2. A pin RXN0 of the edge connector 40 is connected to the clock pin CLKN of the microprocessor U2. The pins RXN0 and RXP0 of the edge connector 40 receive clock signals from the microprocessor U2.

The connection terminals J1-J16 are connected to the pins of the edge connector 40 through traces on the printed circuit board 50. The connection terminals J1-16 transmit signals on the edge connector 40 to a test machine, such as an oscillograph.

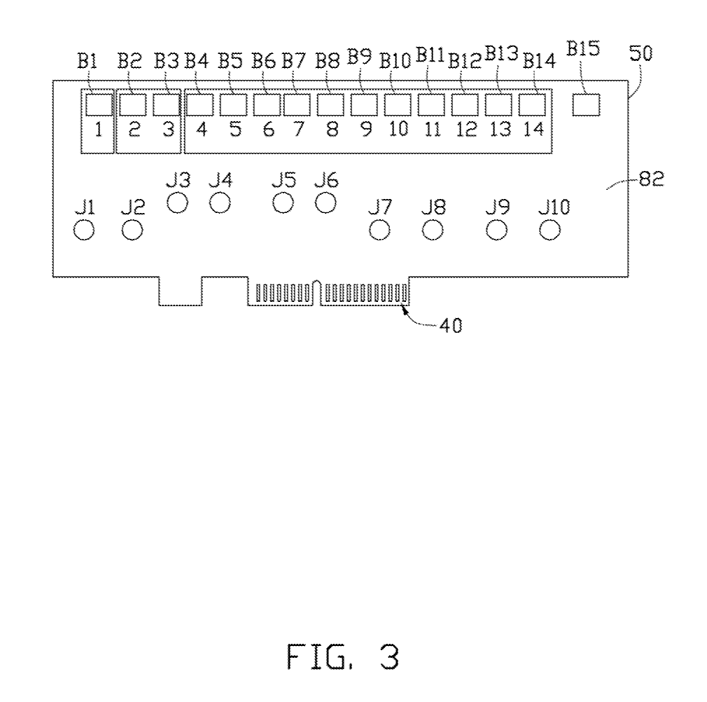

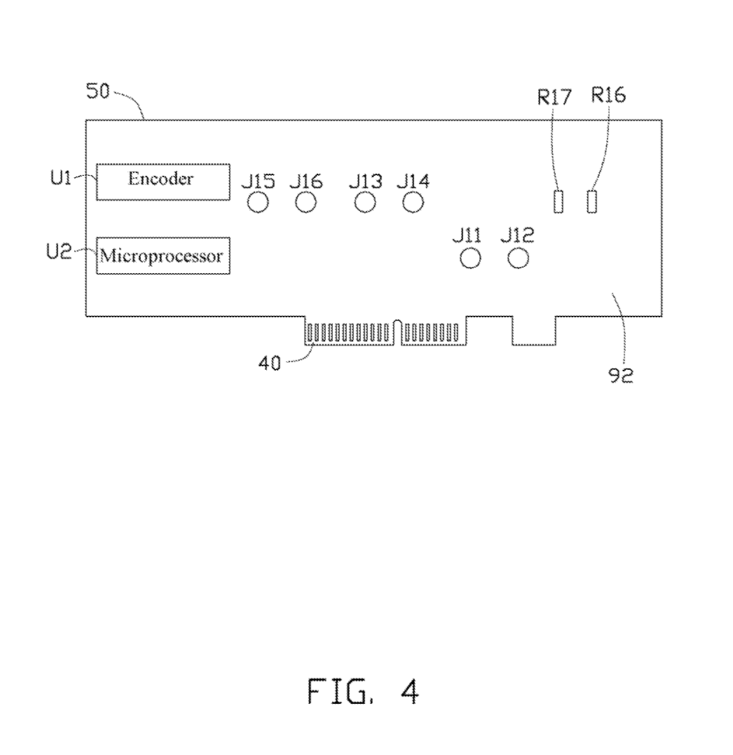

In the embodiment, the switches B1-B15 and the connection terminals J1-J10 are mounted on a first side 82 (shown in FIG. 3) of the printed circuit board 50. The encoder U1, the microprocessor U2, the connection terminals J1-J16, the resistors R16 and R17 are mounted on a second side 92 (shown in FIG. 4) of the printed circuit board 50.

To test the motherboard 30, the edge connector 40 of the test apparatus is plugged into the PCIe slot 35. To test, for example, a second type of PCIe signal from the motherboard 50, the switch B2 is turned on, and the other switches B1 and B3-B15 are turned off. At this time, the input X1 of the encoder U1 receives a low level signal, such as logic 0, the inputs X0, and X2-X13 of the encoder U1 receive high level signals, such as logic 1. The encoder U1 converts the signals input to the inputs X0-X13 to a binary data “0001”, and outputs the binary data “0001” to the inputs X0-X3 of the microprocessor U2. The microprocessor U2 outputs a first type selection signal according to the binary data “0001”. The first type selection signal is input to a central processing unit (CPU) 37 on the motherboard 30 through the edge connector 40 and the PCIe slot 35. As a result, the motherboard 50 outputs a first type of PCIe signal. After a ten millisecond delay, the microprocessor U2 outputs a second type selection signal to the CPU 37. The motherboard 50 outputs the second type of PCIe signal to the terminals of the PCIe slot 35. The second type of PCIe signals are transmitted to the oscillograph through the connection terminals J1-J16. Any of the other signal types are tested in the same manner by turning on the appropriate switch B1-B14 and ensuring the other switches are turned off.

The foregoing description of the exemplary embodiments of the disclosure has been presented only for the purposes of illustration and description and is not intended to be exhaustive or to limit the disclosure to the precise forms disclosed. Many modifications and variations are possible in the light of everything above. The embodiments were chosen and described in order to explain the principles of the disclosure and their practical application so as to enable others of ordinary skill in the art to utilize the disclosure and various embodiments with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A test apparatus for testing peripheral component interconnect express (PCIe) signals transmission of a motherboard, comprising:
a printed circuit board comprising an edge connector;
a plurality of first switches having a same number with the type of the PCIe signals to be tested, wherein a first terminal of each first switch is grounded, a second terminal of each first switch is connected to a direct current (DC) power;
an encoder comprising a plurality of inputs having a same number with the first switches, and a plurality of outputs, wherein the inputs are respectively connected to second terminals of the first switches, the encoder is operable of converting the signals output from the first switches to binary data and outputting the binary data through the outputs;
a microprocessor comprising a plurality of inputs having a same number with the outputs of the encoder, a first clock pin, and a second clock pin, wherein the inputs of the microprocessor are respectively connected to the outputs of the encoder, the microprocessor is operable of outputting corresponding type selection signals according to the binary data and an interval between every two adjacent type selection signals; the first and second clock pins are respectively connected to first and second pins of the edge connector; and
a plurality of connection terminals having a same number with the type of the PCIe signals to be test and connected to the edge connector.

2. The test apparatus of claim 1, further comprising a second switch, wherein the microprocessor further comprises a reset pin, the reset pin is grounded through the second switch.
